(19) United States
(12) Patent Application Publication
(10) Pub. No.: US 2023/0384986 A1
(43) Pub. Date: Nov. 30, 2023

(54) IMAGE PROCESSING DEVICE, IMAGE FORMING DEVICE, AND STORAGE MEDIUM

(71) Applicant: KONICA MINOLTA, INC., Tokyo (JP)

(72) Inventor: Eigo TOMIOKA, Tokyo (JP)

(73) Assignee: KONICA MINOLTA, INC., Tokyo (JP)

(21) Appl. No.: 18/314,293

(22) Filed: May 9, 2023

(30) Foreign Application Priority Data
May 25, 2022 (JP) 2022-084978

(51) Int. Cl. G06F 3/12

(52) U.S. Cl. CPC G06F 3/1205; G06F 3/1242

(57) ABSTRACT

An image processing device includes: a hardware processor that detects a blank region in a recording medium where an image is not formed based on print data of a print job, and that generates print image data in which an image quality adjustment patch is disposed in the detected blank region of the print data.

### REFERENCE TO RELATED APPLICATIONS

The entire disclosure of Japanese Patent Application No. 2022-084978, filed on May 25, 2022, is incorporated herein by reference in its entirety.

### TECHNICAL FIELD

The present disclosure relates to an image processing device, an image forming device, and a storage medium.

### DESCRIPTION OF THE RELATED ART

In the related art, in an image forming device, image quality adjustment patches such as a gradation correction patch and a coverage rate correction patch are formed on a sheet, and an image quality adjustment is performed on an image to be formed.

For example, JP 2010-197586 A describes that a toner discharge pattern (coverage rate correction patch) and a calibration patch (gradation correction patch) are simultaneously formed at the time that toner discharge is executed.

However, in an image forming device that forms an image on a sheet of paper, in a case where an image quality adjustment patch is formed as described in JP 2010-197586 A, the sheet on which the image quality adjustment patch is formed becomes waste paper. In addition, in an image forming device that forms an image on a roll paper, an image quality adjustment patch cannot be formed during printing of a job as described in JP 2010-197586 A.

### SUMMARY OF THE INVENTION

An object of the present disclosure includes providing an image processing device, an image forming device, and a program capable of more suitably forming an image quality adjustment patch.

(Corresponding to claim 1)

To achieve at least one of the abovementioned objects, according to a first aspect of the present disclosure, there is provided an image processing device including: a hardware processor that detects a blank region in a recording medium where an image is not formed based on print data of a print job, and that generates print image data in which an image quality adjustment patch is disposed in the detected blank region of the print data.

(Corresponding to claim 12)

To achieve at least one of the abovementioned objects, according to a second aspect of the present disclosure, there is provided an image forming device including: the image processing device; and an image former that forms an image on the recording medium based on the print image data.

(Corresponding to claim 14)

To achieve at least one of the abovementioned objects, according to a third aspect of the present disclosure, there is provided an image forming device including: a print controller that executes predetermined processing on print data of a print job; and a main body. The print controller includes a first hardware processor that detects a blank region in a recording medium where an image is not formed based on the print data, and that transmits a detection result of the detection to the main body. The main body includes a second hardware processor that generates print image data in which an image quality adjustment patch is disposed in the detected blank region of the print data, and an image former that forms an image on the recording medium based on the print image data.

(Corresponding to claim 15)

In addition, to achieve at least one of the abovementioned objects, according to a fourth aspect of the present disclosure, there is provided an image forming device including: a print controller that executes predetermined processing on print data of a print job; and a main body. The print controller includes a first hardware processor that detects a blank region in a recording medium where an image is not formed based on the print data, that disposes a first image quality adjustment patch in the detected blank region of the print data, and that transmits information related to a remaining blank region after the first image quality adjustment patch is disposed, to the main body. The main body includes a second hardware processor that generates print image data in which a second image quality adjustment patch is disposed in the remaining blank region, and an image former that forms an image on the recording medium based on the print image data.

(Corresponding to claim 16)

To achieve at least one of the abovementioned objects, according to a fifth aspect of the present disclosure, there is provided a non-transitory computer-readable storage medium that stores a program causing a computer of an image processing device to perform: detecting a blank region in a recording medium where an image is not formed based on print data of a print job; and generating print image data in which an image quality adjustment patch is disposed in the detected blank region of the print data.

### BRIEF DESCRIPTION OF THE DRAWINGS

The advantages and features provided by one or more embodiments of the present disclosure will become more fully understood from the detailed description given hereinbelow and the appended drawings which are given by way of illustration only, and thus are not intended as a definition of the limits of the present disclosure, wherein:

FIG. 1 is a schematic view showing a schematic configuration of an image forming device;

FIG. 2 is a block diagram showing a functional configuration of the image forming device;

FIG. 3 is a view showing one example of a gradation correction patch;

FIG. 4 is a view showing one example of a coverage rate correction patch;

FIG. 5 is a flowchart showing patch disposition processing;

FIG. 6A is a view showing one example of a continuous recording medium on which image quality adjustment patches and a job image are formed;

FIG. 6B is a view showing one example of a continuous recording medium on which image quality adjustment patches and a job image are formed;

FIG. 7 is a view showing one example of a continuous recording medium on which image quality adjustment patches and a job image are formed according to a first modification example;

FIG. 8 is a flowchart showing patch disposition processing according to the first modification example;

FIG. 9 is a view showing one example of a continuous recording medium on which image quality adjustment patches and a job image are formed according to the first modification example;

FIG. 10 is a flowchart showing patch disposition processing according to a second modification example;

FIG. 11 is a view showing one example of a continuous recording medium on which image quality adjustment patches and a job image are formed according to the second modification example;

FIG. 12 is a flowchart showing patch disposition processing according to a third modification example; and

FIG. 13 is a flowchart showing patch disposition processing according to a fourth modification example.

### DETAILED DESCRIPTION

Hereinafter, one or more embodiments of the present disclosure will be described with reference to the drawings. However, the scope of the present disclosure is not limited to the disclosed embodiments or illustrated examples.

<Configuration of Image Forming Device>

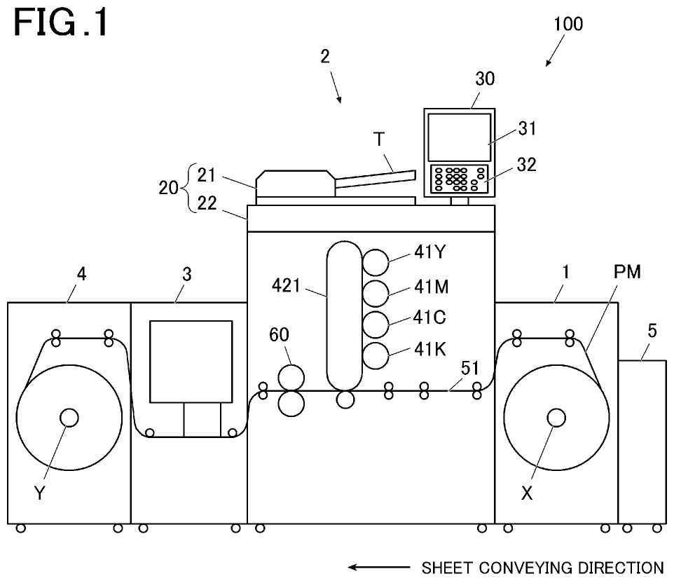

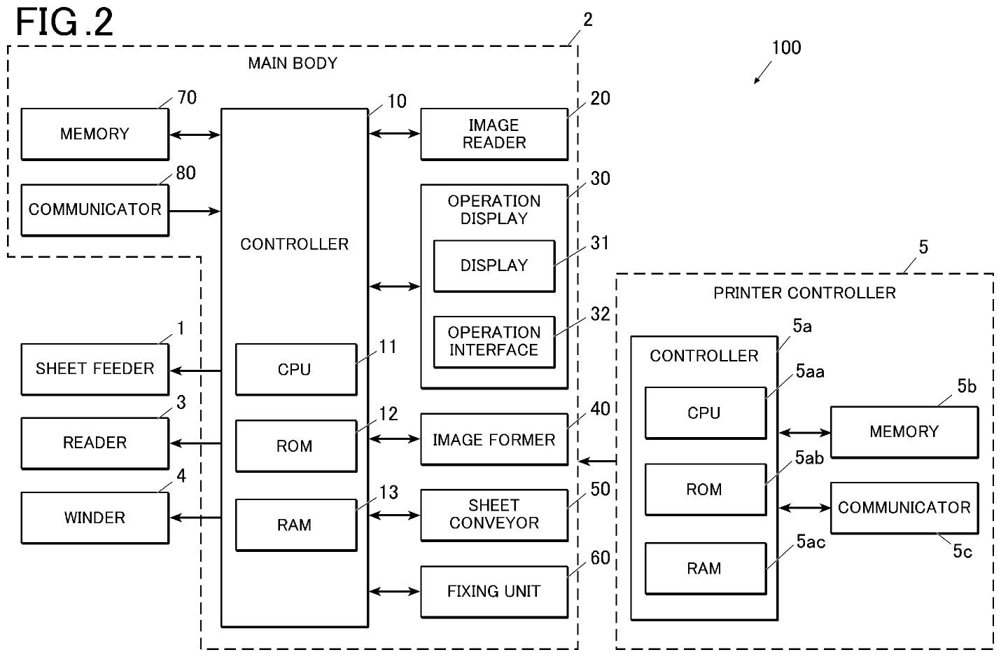

FIG. 1 is a schematic view showing a schematic configuration of an image forming device 100 according to the present embodiment. FIG. 2 is a block diagram showing a functional configuration of the image forming device 100 according to the present embodiment.

The image forming device 100 is a device that uses a continuous recording medium PM having a roll shape, and that forms an image on the continuous recording medium PM.

As shown in FIG. 1, the image forming device 100 is configured such that a print controller 5, a sheet feeder 1, a main body 2, a reader 3, and a winder 4 are connected in order from an upstream side along a conveying direction (sheet conveying direction) of the continuous recording medium PM.

The sheet feeder 1 is a device that feeds the continuous recording medium PM to the main body 2.

For example, the sheet feeder 1 conveys the continuous recording medium PM wound around a support shaft X, to the main body 2 at a constant speed via a plurality of pairs of conveying rollers such as pickup rollers and feed rollers.

The sheet feeding operation of the sheet feeder 1 is controlled by a controller 10 (second hardware processor) provided in the main body 2.

The main body 2 performs image formation through an intermediate transfer method using an electrophotographic process technology.

As shown in FIG. 2, the main body 2 includes the controller 10, an image reader 20, an operation display an image former 40, a sheet conveyor 50, a fixing unit 60, a memory 70, a communicator 80, and the like.

The controller 10 includes a central processing unit (CPU) 11, a read only memory (ROM) 12, a random access memory (RAM) 13, and the like.

The CPU 11 reads a program corresponding to processing contents from the ROM 12, expands the program into the RAM 13, and centrally controls operation of each block of the main body 2, the sheet feeder 1, the reader 3, the winder 4, or the like in cooperation with the expanded program.

The image reader 20 includes an automatic document feeder 21 called an auto document feeder (ADF), a document image scanning device 22 (scanner), and the like.

The automatic document feeder 21 conveys documents placed on a document tray T, using a conveying mechanism, and sends the documents to the document image scanning device 22. A large number of documents (including both sides) placed on the document tray T can be continuously read at once by the automatic document feeder 21.

The document image scanning device 22 reads an image of a document conveyed onto a contact glass from the automatic document feeder 21 or the document placed on the contact glass by optically scanning the document and focusing reflected light from the document on a light-receiving surface of a charge coupled device (CCD) sensor.

The image reader 20 generates image data based on the reading result by the document image scanning device 22.

The operation display 30 is composed of, for example, a liquid crystal display (LCD) with a touch panel, and functions as a display 31 and an operation interface 32.

The display 31 performs display of various operation screens, an image state, an operation status of each function, and the like according to a display control signal input from the controller 10.

The operation interface 32 includes various operation keys such as a numeric keypad and a start key, receives various input operations by a user, and outputs an operation signal to the controller 10.

The image former 40 forms a toner image of each color of yellow (Y), magenta (M), cyan (C), and black (K) on photosensitive drums 41Y, 41M, 41C, and 41K based on image data input from the image reader 20 or image data input from the print controller 5 via the communicator 80. Then, the image former 40 forms an image by sequentially and primarily transferring the formed toner image of each color onto an intermediate transfer belt 421 to overlay the toner images of four colors, and then by secondarily transferring the toner images onto the continuous recording medium PM fed from the sheet feeder 1.

The sheet conveyor 50 includes a conveying path unit 51 including a plurality of conveying rollers, and the like.

The continuous recording medium PM conveyed to the main body 2 is conveyed to the image former 40 by the conveying path unit 51. Then, in the image former 40, the toner images on the intermediate transfer belt 421 are collectively and secondarily transferred onto one surface of the continuous recording medium PM, and are subjected to a fixing step in the fixing unit 60. The continuous recording medium PM on which the image is formed is conveyed to the reader 3.

The fixing unit 60 fixes the toner image to the continuous recording medium PM by heating and pressurizing the continuous recording medium PM, on which the toner image is formed, at a fixing nip.

The memory 70 is composed of, for example, a nonvolatile semiconductor memory (so-called flash memory), a hard disk drive, or the like.

The memory 70 stores document data, various setting information, image data, and the like that are input. These data and the like may be stored in the RAM 13 of the controller 10.

The communicator 80 is composed of, for example, a communication control card such as a local area network (LAN) card, and performs transmission and reception of various data between the print controller 5 connected to a communication network such as LAN or wide area network (WAN) and an external device (for example, a personal computer).

The communicator 80 may be configured to be connected to the print controller 5 via a dedicated line such as a peripheral component interconnect (PCI) connection.

The reader 3 reads the image on the surface of the continuous recording medium PM.

The reader 3 reads the image on the surface of the conveyed continuous recording medium PM, and transmits the reading result to the controller 10.

The reader 3 may be a line sensor, a colorimeter that reads an image at points, or the like, and is not limited to a specific type of reader as long as the reader can read an image. The embodiment has been described as having a configuration that can read an image on one side of a sheet; however, the configuration may be such that images on both sides are read with two readers, and a reversing conveying path may be provided and a sheet may be reversed to read images on both sides of the sheet with one reader.

Particularly, the reader 3 reads a gradation correction patch P1 to be described later.

The reader 3 transmits the reading result of the gradation correction patch P1 to the controller 10, and the controller 10 calculates an adjustment value for gradation correction (correction value) based on the reading result, and applies the adjustment value to a job image formed by the image former 40. An image quality correction method can be performed by adjusting the charging bias of a charging device, the exposure light amount and the exposure position of an exposure device, the developing bias of a developing device, density correction characteristics, or the like. Accordingly, the image can be prevented from changing during output of a print job, and color stabilization and the like can be performed. When an image is formed on the continuous recording medium PM, job image formation is performed while performing an image quality adjustment, so that the image quality adjustment is called real-time image quality adjustment.

The winder 4 is a device that winds the continuous recording medium PM conveyed from the reader 3.

The winder 4 winds the continuous recording medium PM, which is conveyed from the reader 3, around a support shaft Y at a constant speed via a plurality of pairs of conveying rollers (for example, pickup rollers and output rollers).

The winding operation of the winder 4 is controlled by the controller 10.

The print controller 5 creates print image data by performing predetermined processing on print data of a print job received from the external device, and transmits the print image data to the main body 2. Therefore, the print controller 5 functions as an image processing device.

As shown in FIG. 2, the print controller 5 includes a controller 5a (hardware processor and first hardware processor), a memory 5b, and a communicator 5c.

The controller 5a includes a CPU 5aa, a ROM 5ab, a RAM 5ac, and the like.

The CPU 5aa reads a program corresponding to processing contents from the ROM 5ab, expands the program into the RAM 5ac, and centrally controls operation of each block of the print controller 5 in cooperation with the expanded program.

In addition, the controller 5a analyzes the print data of the print job that is received from the external device via the communicator 5c and that is described in a page description language (PDL), and converts the print data into intermediate data.

Next, the controller 5a reads the generated intermediate data, and performs rasterization (raster image processor: RIP) processing thereon to generate RIP image data in a bitmap format for each of the Y, M, C, and K colors.

In addition, the controller 5a detects a blank region in the continuous recording medium PM where an image is not formed based on the print data of the print job. The controller 5a functions as a detector. The blank region is a region where a character, an image, or the like is not formed, and is a region of a predetermined area or greater and made up of only white pixels.

In addition, the controller 5a generates print image data in which image quality adjustment patches are disposed in the blank region detected by the detector for print data.

In addition, the controller 5a receives the setting of priorities for a plurality of types of the image quality adjustment patches by an operation of the user. The controller 5a functions as a receiver.

The memory 5b is composed of, for example, a nonvolatile semiconductor memory, a hard disk drive, or the like.

The memory 5b stores the print data of the print job received from the external device, the print image data generated by performing the predetermined processing thereon, various setting information, and the like. These data and the like may be stored in the ROM 5ab of the controller 5a.

In addition, the memory 5b stores the image data of the image quality adjustment patches.

The communicator 5c is composed of, for example, a communication control card such as a LAN card, and performs transmission and reception of various data between the main body 2 connected to a communication network such as LAN or WAN and the external device.

The communicator 5c may be configured to be connected to the main body 2 via a dedicated line such as a PCI connection.

<Image Quality Adjustment Patch>

The image quality adjustment patch will be described.

The image quality adjustment patch is an image that is disposed in an RIP image by the print controller 5, and that is formed on the continuous recording medium PM by the main body 2.

The image quality adjustment patch includes the gradation correction patch P1 and a coverage rate correction patch P2. The coverage rate is specified based on a ratio of a region to which toner is applied to the total region of a recording medium or an output material and on a gradation value in the region to which toner is applied.

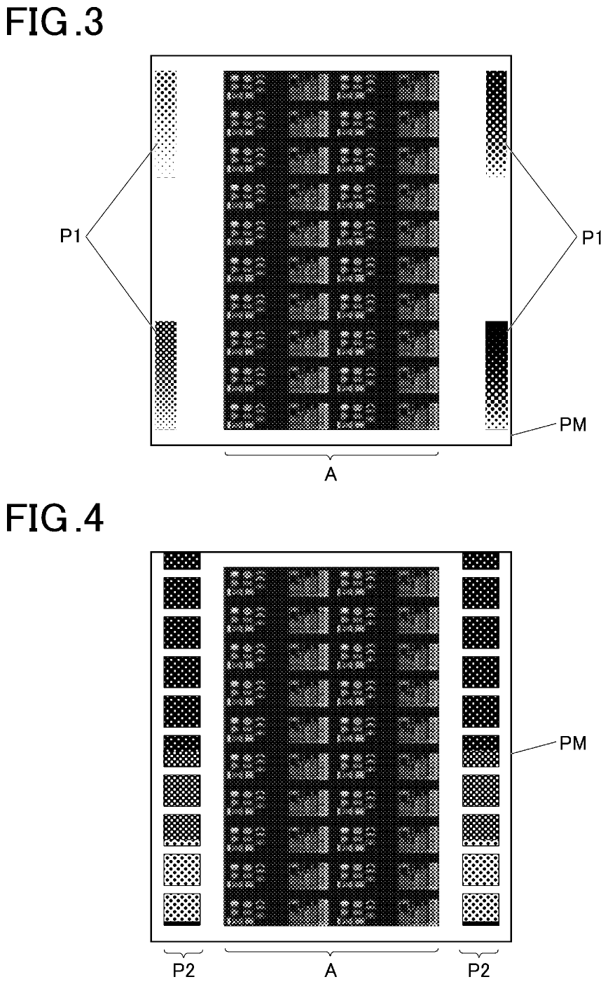

FIG. 3 shows an example of the gradation correction patch P1 and a job image A of a print job formed on the continuous recording medium PM.

The gradation correction patch P1 is a patch used to adjust the colors of the image formed by the main body 2 as described above. For example, as shown in FIG. 3, the gradation correction patch P1 is a step wedge image made up of patch-shaped density steps of which the density changes stepwise.

In addition, since the gradation correction patch P1 is read by the reader 3 as described above, the gradation correction patch P1 is formed at positions on the continuous recording medium PM (for example, both ends of the continuous recording medium PM) where the reader 3 can read the gradation correction patch P1. Namely, the positions on the continuous recording medium PM where the gradation correction patch P1 is formed are determined in advance (there is a limitation on disposition positions).

FIG. 4 shows an example of the coverage rate correction patch P2 and the job image A of a print job formed on the continuous recording medium PM.

The coverage rate correction patch P2 is a patch used to consume old toner when the coverage rate is low in the print image data (when the amount of toner consumption is small).

In addition, the coverage rate correction patch P2 may be formed at any position on the continuous recording medium PM. Namely, there is no limitation on the disposition positions of the coverage rate correction patch P2 on the continuous recording medium PM.

In the present embodiment, the image quality adjustment patches are disposed in the RIP image in order starting from the patch with the highest priority.

As described above, since there is a limitation on the disposition positions of the gradation correction patch P1 on the continuous recording medium PM, the gradation correction patch P1 has a higher priority than the coverage rate correction patch P2.

The priorities for the image quality adjustment patches may be arbitrarily set via the communicator 5c by the user. Namely, the controller 5a of the print controller 5 receives the setting of the priorities by an operation of the user.

<Operation of Image Forming Device>

(Patch Disposition Processing)

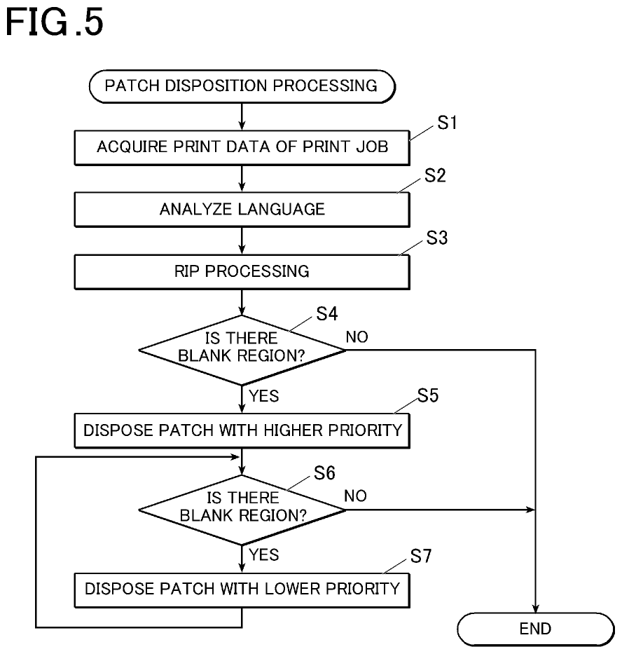

FIG. 5 is a flowchart showing patch disposition processing executed in the image forming device 100.

When a blank region where an image is not formed based on print data of a print job exists on the continuous recording medium PM, the controller 5a of the print controller 5 executes the patch disposition processing to generate print image data in which image quality adjustment patches are disposed in the blank region.

First, the controller 5a acquires print data of a print job by receiving the print data of the print job from the external device (step S1). The controller 5a acquires the print data of the print job from the memory 5b.

Next, the controller 5a analyzes the page description language of the print data of the print job acquired in step S1, and generates intermediate data (step S2).

Next, the controller 5a reads the intermediate data generated in step S2, and performs rasterization processing thereon to generate RIP image data in a bitmap format (step S3).

Next, the controller 5a determines whether or not a blank region where an image is not formed based on the print data of the print job exists on the continuous recording medium PM (step S4).

Specifically, when the controller 5a analyzes the page description language of the print data of the print job in step S2, the controller 5a acquires coordinates where a text or an image is disposed, and detects coordinates where a text or an image is not disposed, as a blank region.

A blank region detection method is not limited to the above-described method. The controller 5a may detect a blank region by image-analyzing the RIP image generated in step S3.

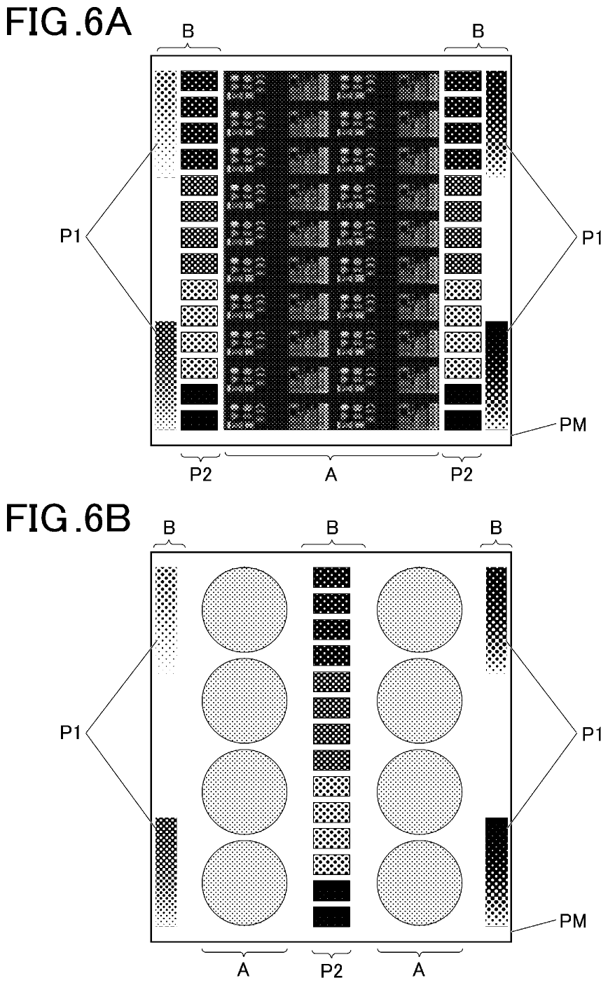

FIGS. 6A and 6B show examples of the continuous recording medium PM after the job image A of the print job is formed. In the examples shown in FIGS. 6A and 6B, a region B is a blank region.

When a blank region does not exist (step S4: NO), the controller 5a ends the processing. Namely, the controller 5a does not dispose the image quality adjustment patches in the RIP image.

In addition, when a blank region exists (step S4: YES), the controller 5a disposes the patch with a higher priority, namely, the gradation correction patch P1 in the blank region (step S5).

In the examples shown in FIGS. 6A and 6B, the gradation correction patch P1 is disposed at both ends of the continuous recording medium PM, which are in the blank region (region B) and which are at positions where the reader 3 can read the gradation correction patch P1.

Next, the controller 5a determines whether or not there is a blank region in the RIP image after the patch with a higher priority is disposed in step S5 (step S6).

When there is no blank region in the RIP image after the patch with a higher priority is disposed (step S6: NO), the controller 5a ends the processing. Namely, the controller 5a does not dispose the patch with a lower priority in the RIP image.

In addition, when there is a blank region in the RIP image after the patch with a higher priority is disposed (step S6: YES), the controller 5a disposes the patch with a lower priority, namely, the coverage rate correction patch P2 in the blank region (step S5).

In the examples shown in FIGS. 6A and 6B, the coverage rate correction patch P2 is disposed in the blank region (region B) and at positions where the gradation correction patch P1 is not disposed. Since there is no limitation on the disposition positions of the coverage rate correction patch P2 on the continuous recording medium PM, the coverage rate correction patch P2 may be disposed in the vicinities of both the ends of the continuous recording medium PM as shown in FIG. 6A, and may be disposed at a central portion of the continuous recording medium PM as shown in FIG. 6B.

Namely, the controller 5a disposes the image quality adjustment patch with no limitation on the disposition position (coverage rate correction patch P2), in a region other than a region where the image quality adjustment patch with a limitation on the disposition position (gradation correction patch P1).

Next, the controller 5a proceeds with the process to step S6.

In step S6 of the second iteration, the controller 5a determines whether or not there is a blank region in the RIP image after the image quality adjustment patches are disposed in steps S5 and S7. Namely, the controller repeats steps S6 and S7 until there is no blank region found in the RIP image after the image quality adjustment patches are disposed in steps S5 and S7.

When there is no blank region in the RIP image after the image quality adjustment patches are disposed in steps S5 and S7 (step S6: NO), the controller 5a ends the processing.

Then, the controller 5a transmits RIP image data after the image quality adjustment patches are disposed, to the main body 2 as print image data. Namely, the controller 5a generates the print image data in which image quality adjustment patches are disposed in the blank region detected by the detector for print data.

<First Modification Example>

Next, a first modification example of the embodiment will be described.

Hereinafter, differences from the embodiment will be mainly described.

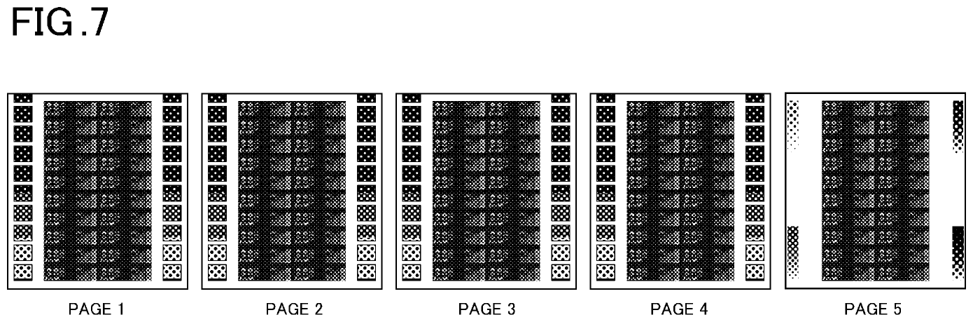

In the present modification example, the frequency of disposing the gradation correction patch P1 and the coverage rate correction patch P2 in an RIP image is provisionally set in advance as a predetermined criterion. For example, the gradation correction patch P1 is disposed in one page of five pages of the RIP image, and the coverage rate correction patch P2 is disposed in the remaining four pages of the five pages. In this case, FIG. 7 shows an example of the continuous recording medium PM after the image quality adjustment patches and the job image A of a print job are formed.

In the example shown in FIG. 7, the coverage rate correction patch P2 is disposed in pages 1 to 4, and the gradation correction patch P1 is disposed in page 5.

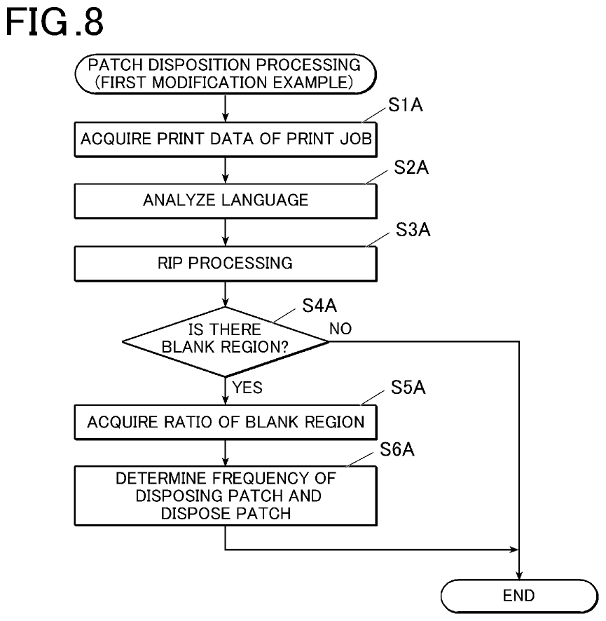

FIG. 8 is a flowchart showing patch disposition processing executed in the image forming device 100 of the present modification example.

In the patch disposition processing of the present modification example, first, the controller 5a performs steps S1A to S4A that are the same as steps S1 to S4 of the embodiment.

When a blank region exists (step S4A: YES), the controller 5a acquires a ratio of the blank region to the continuous recording medium PM (step S5A).

Next, the controller 5a determines the frequency of disposing the image quality adjustment patches in the RIP image based on the ratio of the blank region acquired in step S5A, disposes the image quality adjustment patches in the RIP image at the frequency (step S6A), and ends the processing.

Specifically, first, the controller 5a determines the frequency of disposing the coverage rate correction patch P2 according to the ratio of the blank region acquired in step S5A. The frequency may be set to the extent that old toner can be sufficiently consumed (for example, to the extent that the coverage rate can be maintained at 5% or more). Then, the controller 5a determines the frequency of disposing the gradation correction patch P1 according to the frequency of disposing the coverage rate correction patch P2.

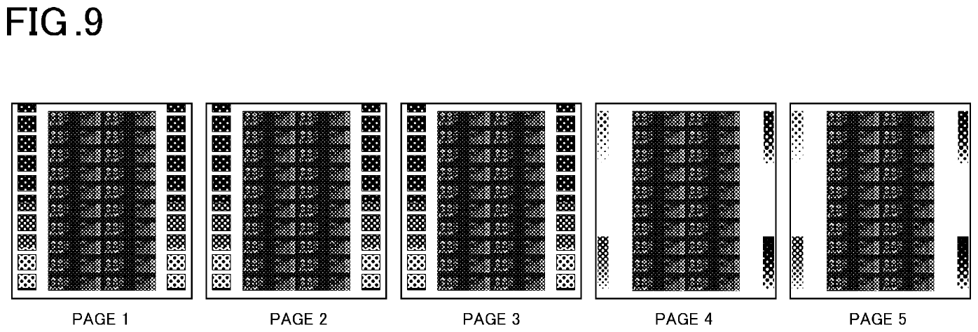

For example, as shown in FIG. 9, when the controller 5a determines that the coverage rate correction patch P2 is disposed in three pages (pages 1 to 3) of five pages of an RIP image, the controller 5a determines that the gradation correction patch P1 is disposed in the remaining two pages (pages 4 and 5) of the five pages.

In such a case, since the frequency of disposing the gradation correction patch P1 is increased beyond the provisionally set frequency (predetermined criterion), the gradation can be corrected with higher accuracy Namely, the controller 5a sets the frequency of disposing the image quality adjustment patch with the highest priority (gradation correction patch P1) among a plurality of types of the image quality adjustment patches to be higher than the predetermined criterion, and sets the image quality adjustment patch with the lowest priority (coverage rate correction patch P2) to be lower than the predetermined criterion.

<Second Modification Example>

Next, a second modification example of the embodiment will be described.

Hereinafter, differences from the embodiment will be mainly described.

In the present modification example, the controller 5a determines whether or not the size of a blank region is less than a predetermined threshold value. The controller 5a functions as a determiner.

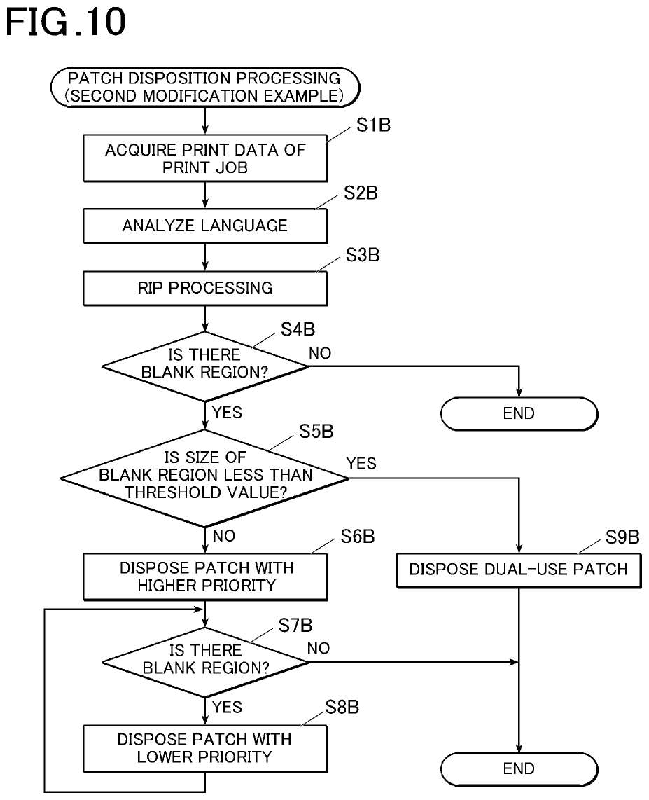

FIG. 10 is a flowchart showing patch disposition processing executed in the image forming device 100 of the present modification example.

In the patch disposition processing of the present modification example, first, the controller 5a performs steps S1B to S4B that are the same as steps S1 to S4 of the embodiment.

When a blank region exists (step S4B: YES), the controller 5a determines whether or not the size of the blank region is less than the predetermined threshold value (step S5B). The predetermined threshold value is a size at which the gradation correction patch P1 and the coverage rate correction patch P2 can be individually disposed in an RIP image, and is set in advance.

When the size of the blank region is the predetermined threshold value or greater (step S5B: NO), the controller 5a performs steps S6B to S8B that are the same as steps S5 to S7 of the embodiment.

In addition, when the size of the blank region is less than the predetermined threshold value (step S5B: YES), the controller 5a disposes a dual-use patch P3 in the blank region (step S9B), and ends the processing. The dual-use patch P3 is an image quality adjustment patch, and is a patch having the functions of both the gradation correction patch P1 and the coverage rate correction patch P2.

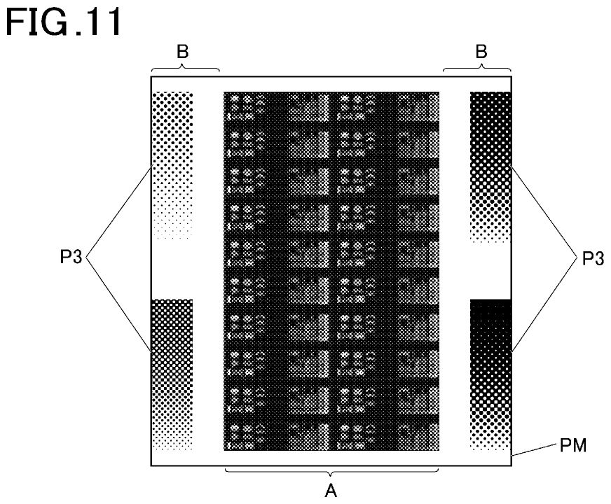

FIG. 11 shows an example of the continuous recording medium PM after the dual-use patch P3 and the job image A of a print job are formed. In the example shown in FIG. 11, the dual-use patch P3 is disposed at both ends of the continuous recording medium PM, which are in the blank region (region B) and which are at positions where the reader 3 can read the dual-use patch P3. For example, as shown in FIG. 11, the dual-use patch P3 is a patch obtained by enlarging the gradation correction patch P1 in the conveying direction of the continuous recording medium PM and in a direction orthogonal to the conveying direction.

<Third Modification Example>

Next, a third modification example of the embodiment will be described.

Hereinafter, differences from the embodiment will be mainly described.

In the present modification example, the controller 5a of the print controller 5 transmits a detection result (blank region information) of the detector to the main body 2. The controller 5a functions as a transmitter.

In addition, the controller 10 of the main body 2 generates print image data in which image quality adjustment patches are disposed in the blank region detected by the detector for print data.

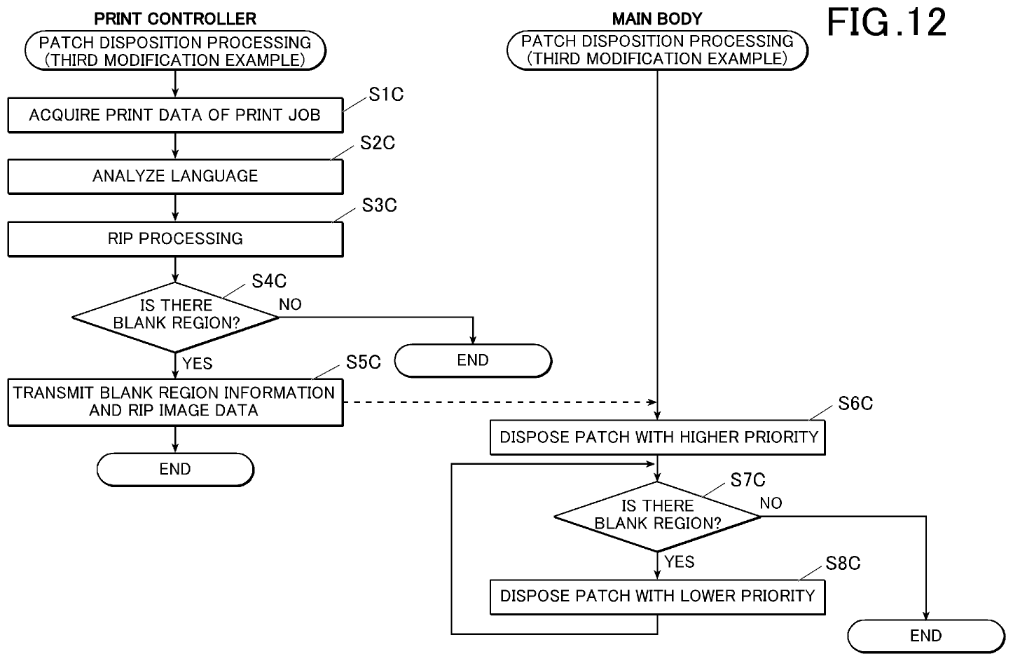

FIG. 12 is a flowchart showing patch disposition processing executed in the image forming device 100 of the present modification example.

In the present modification example, the controller 5a of the print controller 5 and the controller 10 of the main body 2 execute the patch disposition processing.

In the patch disposition processing of the present modification example, first, the controller 5a performs steps S1C to S4C that are the same as steps S1 to S4 of the embodiment.

When a blank region exists (step S4C: YES), the controller 5a transmits blank region information that is the result detected in step S4C and RIP image data generated in step S3C, to the main body 2 (step S5C), and ends the processing.

The controller 10 of the main body 2 which receives the blank region information and the RIP image data performs steps S6C to S8C that are same as steps S5 to S7 of the embodiment, based on the blank region information, and ends the processing.

<Fourth Modification Example>

Next, a fourth modification example of the embodiment will be described.

Hereinafter, differences from the embodiment will be mainly described.

In the present modification example, the controller 5a of the print controller 5 disposes a first image quality adjustment patch (for example, the gradation correction patch P1) in a blank region detected by the detector for print data. The controller 5a functions as a first controller.

In addition, the controller 5a transmits information related to a remaining blank region (remaining blank region information) after the first image quality adjustment patch is disposed by the first controller, to the main body 2. The controller 5a functions as a transmitter.

In addition, the controller 10 of the main body 2 generates print image data in which a second image quality adjustment patch (for example, the coverage rate correction patch P2) is disposed in the remaining blank region. The controller 10 functions as a second controller.

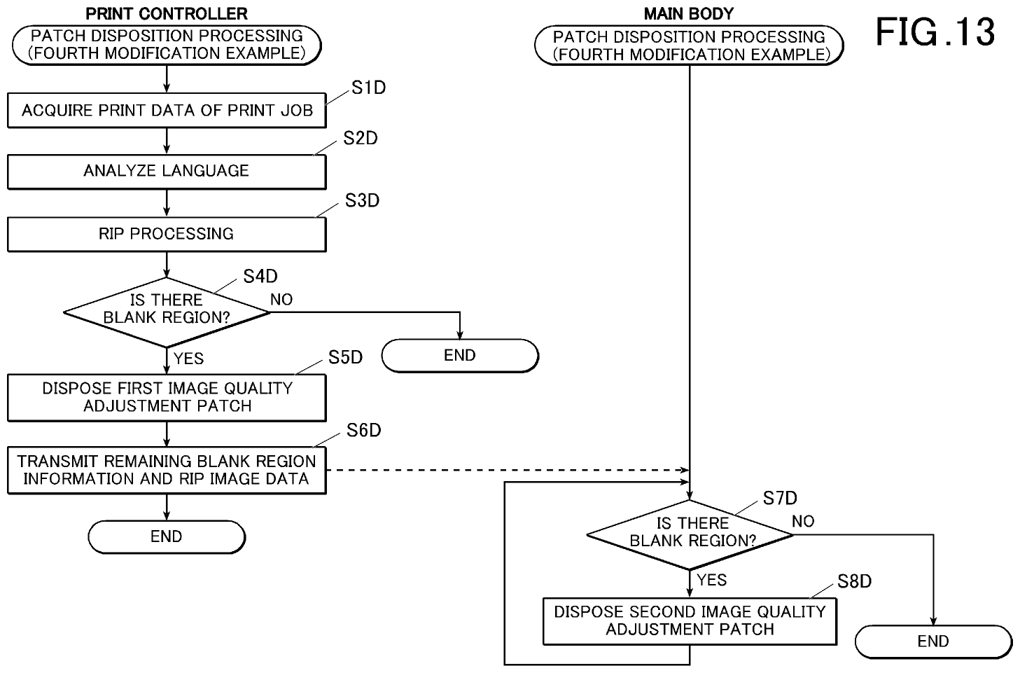

FIG. 13 is a flowchart showing patch disposition processing executed in the image forming device 100 of the present modification example.

In the present modification example, the controller 5a of the print controller 5 and the controller 10 of the main body 2 execute the patch disposition processing.

In the patch disposition processing of the present modification example, first, the controller 5a performs steps S1D to S4D that are the same as steps S1 to S4 of the embodiment.

When a blank region exists (step S4D: YES), the controller 5a disposes the first image quality adjustment patch (for example, the gradation correction patch P1) in the blank region (step S5D).

Next, the controller 5a transmits the remaining blank region information after the first image quality adjustment patch is disposed and the RIP image data after the first image quality adjustment patch is disposed, to the main body 2 (step S6D), and ends the processing.

The controller 10 of the main body 2 which receives the remaining blank region information and the RIP image data determines whether or not there is a blank region in the RIP image after the first image quality adjustment patch is disposed, based on the remaining blank region information (step S7D).

When there is no blank region in the RIP image after the first image quality adjustment patch is disposed (step S7D: NO), the controller 10 ends the processing. Namely, the controller 10 does not dispose the second image quality adjustment patch in the RIP image.

In addition, when there is a blank region in the RIP image after the first image quality adjustment patch is disposed (step S7D: YES), the controller 10 disposes the second image quality adjustment patch (for example, the coverage rate correction patch P2) in the blank region (step S8D), and proceeds with the processing to step S7D.

In step S7D of the second iteration, the controller 10 determines whether or not there is a blank region in the RIP image after the image quality adjustment patches are disposed in steps S5D and S8D. Namely, the controller 10 repeats steps S7D and S8D until there is no blank region found in the RIP image after the image quality adjustment patches are disposed in steps S5D and S8D.

When there is no blank region in the RIP image after the image quality adjustment patches are disposed in steps S5D and S8D (step S7D: NO), the controller 10 ends the processing.

As described above, an image processing device (print controller 5) according to the present embodiment includes a detector (controller 5a) that detects a blank region in a recording medium (continuous recording medium PM) where an image is not formed based on print data of a print job, and a controller 5a that generates print image data in which an image quality adjustment patch is disposed in the blank region detected by the detector for print data.

Therefore, since the image quality adjustment patch can be disposed in the blank region where a job image of the print job is not formed, it is possible to more suitably form the image quality adjustment patch together with the job image.

In addition, in the image processing device according to the present embodiment, the detector detects the blank region by analyzing RIP image data obtained by performing RIP processing on the print data.

Therefore, the blank region can be easily detected by image-analyzing an RIP image.

In addition, in the image processing device according to the present embodiment, the detector detects the blank region by analyzing a description language of the print data.

Therefore, the blank region can be easily detected by analyzing the language of the print data.

In addition, in the image processing device according to the present embodiment, the image quality adjustment patch includes a gradation correction patch and a coverage rate correction patch.

Therefore, by performing a gradation correction based on the gradation correction patch, the image can be prevented from changing during output of the print job, and color stabilization and the like can be performed. In addition, since old toner is consumed using the coverage rate correction patch, even when an output material has a low coverage rate, the toner can be prevented from accumulating in the main body 2.

In addition, in the image processing device according to the present embodiment, the controller 5a disposes a plurality of types of the image quality adjustment patches in a descending order of priorities set for the image quality adjustment patches.

Therefore, for example, by preferentially disposing the gradation correction patch P1, a real-time image quality adjustment can be performed at a higher frequency, and a printed material with high image quality adjustment accuracy can be output.

In addition, the image processing device according to the present embodiment includes a receiver (controller 5a) that receives a setting of the priorities by an operation of a user.

Therefore, the image quality adjustment patches can be disposed in the descending order of the priorities desired by the user.

In addition, in the image processing device according to the present embodiment, the controller 5a disposes the image quality adjustment patch with no limitation on a disposition position, in a region other than a region where the image quality adjustment patch with a limitation on a disposition position is disposed.

Therefore, it is possible to dispose the image quality adjustment patch with no limitation on the disposition position together with the image quality adjustment patch with a limitation on the disposition position, while preferentially disposing the image quality adjustment patch with a limitation on the disposition position.

In addition, in the image processing device according to the present embodiment, the controller 5a enables the image quality adjustment patch with no limitation on the disposition position to be disposed in an entirety of the blank region.

Therefore, even when the position of the blank region is any position in a print image, the image quality adjustment patch with no limitation on the disposition position (coverage rate correction patch P2) can be disposed.

In addition, in the image processing device according to the present embodiment, the controller 5a determines a frequency of disposing the image quality adjustment patch based on a ratio of the blank region to the recording medium.

Therefore, for example, by determining the frequency of disposing the coverage rate correction patch P2 according to the ratio of the blank region, old toner can be sufficiently consumed using the coverage rate correction patch P2.

In addition, in the image processing device according to the present embodiment, the controller 5a sets a frequency of disposing the image quality adjustment patch with a highest priority (gradation correction patch P1) among a plurality of types of the image quality adjustment patches to be higher than a predetermined criterion, and sets a frequency of disposing the image quality adjustment patch with a lowest priority (coverage rate correction patch P2) to be lower than the predetermined criterion.

Therefore, since the frequency of disposing the gradation correction patch P1 can be increased beyond the predetermined criterion, the gradation can be corrected with higher accuracy.

In addition, the image processing device according to the present embodiment includes a determiner (controller 5a) that determines whether or not a size of the blank region is less than a predetermined threshold value, and the controller 5a disposes a patch having functions of a plurality of types of the image quality adjustment patches (dual-use patch P3) when the determiner determines that the size of the blank region is less than the threshold value.

Therefore, even when the blank region has such a size that the gradation correction patch P1 and the coverage rate correction patch P2 cannot be individually disposed, both a gradation correction and the consumption of old toner can be performed by disposing the dual-use patch P3.

In addition, an image forming device 100 according to the present embodiment includes: the image processing device (print controller 5); and an image former 40 that forms an image on the recording medium based on the print image data.

Therefore, it is possible to more suitably dispose the image quality adjustment patch together with a job image of the print job, based on the print image data in which the image quality adjustment patch is disposed in the blank region where the job image is not formed.

In addition, in the image forming device 100 according to the present embodiment, the recording medium includes a continuous recording medium PM.

Therefore, even during printing of the job, it is possible to form the image quality adjustment patch together with the job image.

In addition, an image forming device 100 according to the present embodiment includes: a print controller that executes predetermined processing on print data of a print job; and a main body 2. The print controller 5 includes a detector (controller 5a) that detects a blank region in a recording medium where an image is not formed based on the print data, and a transmitter (controller 5a) that transmits a detection result of the detection to the main body 2. The main body 2 includes a controller 10 that generates print image data in which an image quality adjustment patch is disposed in the blank region detected by the detector for the print data, and an image former 40 that forms an image on the recording medium based on the print image data.

Therefore, since the image quality adjustment patch can be disposed in the blank region where a job image of the print job is not formed, it is possible to more suitably form the image quality adjustment patch together with the job image.

In addition, an image forming device 100 according to the present embodiment includes: a print controller that executes predetermined processing on print data of a print job; and a main body 2. The print controller 5 includes a detector (controller 5a) that detects a blank region in a recording medium where an image is not formed based on the print data, a first controller (controller 5a) that disposes a first image quality adjustment patch in the blank region detected by the detector for the print data, and a transmitter (controller 5a) that transmits information related to a remaining blank region after the first image quality adjustment patch is disposed by the first controller, to the main body 2. The main body 2 includes a second controller (controller 10) that generates print image data in which a second image quality adjustment patch is disposed in the remaining blank region, and an image former 40 that forms an image on the recording medium based on the print image data.

Therefore, since the image quality adjustment patch can be disposed in the blank region where a job image of the print job is not formed, it is possible to more suitably form the image quality adjustment patch together with the job image.

The present embodiment of the present disclosure has been described above; however, the description of the embodiment illustrates one exemplary example of the image forming device according to the present disclosure, and the present disclosure is not limited thereto.

For example, in the embodiment, the gradation correction patch P1 has a higher priority than the coverage rate correction patch P2. Alternatively, the priorities for the image quality adjustment patches may be arbitrarily set via the communicator 5c by the user; however, the present disclosure is not limited thereto.

The controller 5a of the print controller 5 may set the priorities for the image quality adjustment patches according to the contents of the print data or the state of the main body 2.

In addition, regarding the frequency of disposition in the RIP image, a priority is given to the coverage rate correction patch P2, but the gradation correction patch P1 may be preferentially disposed at positions on the continuous recording medium PM (for example, both ends of the continuous recording medium PM) where the reader 3 can read the gradation correction patch P1.

In addition, in a case where the reader 3 is configured to be movable, there is no limitation on the disposition position of the gradation correction patch P1. For this reason, when the coverage rate of the print job is the predetermined criterion or less, the coverage rate correction patch P2 may be preferentially disposed in the RIP image, and when the coverage rate is higher than the predetermined criterion, the gradation correction patch P1 may be preferentially disposed in the RIP image.

In addition, the image forming device 100 according to the embodiment performs image formation on the continuous recording medium PM that is a windable continuous medium; however, the present disclosure is not limited thereto. The image forming device 100 may perform image formation on a sheet of paper or the like that is not a continuous medium. By applying the present disclosure to an image forming device that performs image formation on a sheet of paper or the like, it is possible to perform a gradation correction or the consumption of old toner during printing of a job, together with the printing of a job image, so that it is possible to prevent the occurrence of waste paper on which only the image quality adjustment patch is printed.

In addition, the controller 10 of the main body 2 may have the function of the image processing device.

In addition, the detailed configurations and detailed operations of the image forming device can also be changed as appropriate without departing the concept of the present disclosure.

Although embodiments of the present disclosure have been described and illustrated in detail, the disclosed embodiments are made for purposes of illustration and example only and not limitation. The scope of the present disclosure should be interpreted by terms of the appended claims.

1. An image processing device comprising:
a hardware processor that detects a blank region in a recording medium where an image is not formed based on print data of a print job, and that generates print image data in which an image quality adjustment patch is disposed in the detected blank region of the print data.

2. The image processing device according to claim 1, wherein the hardware processor detects the blank region by analyzing RIP image data obtained by performing RIP processing on the print data.

3. The image processing device according to claim 1, wherein the hardware processor detects the blank region by analyzing a description language of the print data.

4. The image processing device according to claim 1, wherein the image quality adjustment patch includes a gradation correction patch and a coverage rate correction patch.

5. The image processing device according to claim 4, wherein the hardware processor disposes a plurality of types of the image quality adjustment patches in a descending order of priorities set for the image quality adjustment patches.

6. The image processing device according to claim 5, wherein the hardware processor receives a setting of the priorities by an operation of a user.

7. The image processing device according to claim 1, wherein the hardware processor disposes the image quality adjustment patch with no limitation on a disposition position, in a region other than a region where the image quality adjustment patch with a limitation on a disposition position is disposed.

8. The image processing device according to claim 7, wherein the hardware processor enables the image quality adjustment patch with no limitation on the disposition position to be disposed in an entirety of the blank region.

9. The image processing device according to claim 1, wherein the hardware processor determines a frequency of disposing the image quality adjustment patch based on a ratio of the blank region to the recording medium.

10. The image processing device according to claim 9, wherein the hardware processor sets a frequency of disposing the image quality adjustment patch with a highest priority among a plurality of types of the image quality adjustment patches to be higher than a predetermined criterion, and sets a frequency of disposing the image quality adjustment patch with a lowest priority to be lower than the predetermined criterion.

11. The image processing device according to claim 1, wherein the hardware processor determines whether or not a size of the blank region is less than a predetermined threshold value, and disposes a patch having functions of a plurality of types of the image quality adjustment patches when the hardware processor determines that the size of the blank region is less than the threshold value.

12. An image forming device comprising:
the image processing device according to claim 1; and
an image former that forms an image on the recording medium based on the print image data.

13. The image forming device according to claim 12, wherein the recording medium includes a continuous recording medium.

14. An image forming device comprising:
a print controller that executes predetermined processing on print data of a print job; and
a main body, wherein
the print controller includes a first hardware processor that detects a blank region in a recording medium where an image is not formed based on the print data, and that transmits a detection result of the detection to the main body, and
the main body includes a second hardware processor that generates print image data in which an image quality adjustment patch is disposed in the detected blank region of the print data, and an image former that forms an image on the recording medium based on the print image data.

15. An image forming device comprising:
a print controller that executes predetermined processing on print data of a print job; and
a main body, wherein
the print controller includes a first hardware processor that detects a blank region in a recording medium where an image is not formed based on the print data, that disposes a first image quality adjustment patch in the detected blank region of the print data, and that transmits information related to a remaining blank region after the first image quality adjustment patch is disposed, to the main body, and
the main body includes a second hardware processor that generates print image data in which a second image quality adjustment patch is disposed in the remaining blank region, and an image former that forms an image on the recording medium based on the print image data.

16. A non-transitory computer-readable storage medium that stores a program causing a computer of an image processing device to perform:
detecting a blank region in a recording medium where an image is not formed based on print data of a print job; and
generating print image data in which an image quality adjustment patch is disposed in the detected blank region of the print data.
